(19) United States
(12) Patent Application Publication
(10) Pub. No.: US 2013/0120099 A1
(43) Pub. Date: May 16, 2013

(54) TRANSFORMER

(71) Applicants: Duck Jin AN, Suwon (KR); Ki Hung Nam, Suwon (KR); Myeong Sik Cheon, Suwon (KR); Sang Joon Seo, Suwon (KR)

(72) Inventors: Duck Jin AN, Suwon (KR); Ki Hung Nam, Suwon (KR); Myeong Sik Cheon, Suwon (KR); Sang Joon Seo, Suwon (KR)

(73) Assignee: SAMSUNG ELECTRO-MECHANICS CO., LTD.

(21) Appl. No.: 13/613,599

(22) Filed: Sep. 13, 2012

(30) Foreign Application Priority Data
Nov. 11, 2011 (KR) 10-2011-0117798

(51) Int. Cl. H01F 27/00

(52) U.S. Cl. 336/221

(57) ABSTRACT

There is provided a transformer capable of easily securing an insulation distance between a core and coils. The transformer includes: a bobbin including a pipe shaped body part having a through-hole formed therein and flange parts protruding outwardly from both ends of the body part; a plurality of coils wound on the body part of the bobbin; and a core inserted into the through-hole of the bobbin to form a magnetic circuit, wherein both an outer surface and an outer peripheral surface of the flange parts are disposed to be spaced apart from an inner peripheral surface of a core by a predetermined interval.

### CROSS-REFERENCE TO RELATED APPLICATIONS

This application claims the priority of Korean Patent Application No. 10-2011-0117798 filed on Nov. 11, 2011, in the Korean Intellectual Property Office, the disclosure of which is incorporated herein by reference.

### BACKGROUND OF THE INVENTION

1. Field of the Invention

The present invention relates to a transformer capable of easily securing an insulation distance between a core and coils.

2. Description of the Related Art

Generally, in order to drive an electronic device, driving power is required, and in order to supply driving power to an electronic device, a power supply is required.

A power supply includes a transformer transforming commercial power or other input power into desired power (for example, direct current (DC) power).

A transformer according to the related art mainly has a form in which a primary coil and a secondary coil are sequentially wound on a single bobbin and a core is coupled to the bobbin via a through-hole of the bobbin.

In the transformer according to the related art as described above, in order to provide insulation between the coils wound on the bobbin and the core, a method of winding insulating tape around outer surfaces of the coils and inserting an insulating cover between the coils and the cover has been mainly used.

However, in the case in which an insulating member (the insulating tape or the insulating cover) is used as described above, since a process of winding the insulating tape or a process of inserting the cover should be necessarily performed, the number of manufacturing processes increases and an additional material cost such as a cost of the insulating tape, the cover, or the like, may be increased.

### SUMMARY OF THE INVENTION

An aspect of the present invention provides a transformer capable of securing an insulation distance between coils and a core without using a separate insulating member.

According to an aspect of the present invention, there is provided a transformer including: a bobbin including a pipe shaped body part having a through-hole formed therein and a flange part protruding outwardly of the body part; a plurality of coils wound on the body part of the bobbin; and a core inserted into the through-hole of the bobbin to form a magnetic circuit, wherein both an outer surface and an outer peripheral surface of the flange part are disposed to be spaced apart from an inner peripheral surface of a core by a predetermined interval.

Apart of the core, disposed on an outer portion of the body part, may have an upper surface formed on approximately the same plane as that of an upper surface of the bobbin.

The bobbin may include a terminal connection part protruding from the outer surface of the flange part and having an external connection terminal connected thereto.

The terminal connection part may protrude from a position spaced apart from the through-hole by a predetermined distance in a downward direction.

The core may have a lower surface spaced apart from an upper surface of the terminal connection part by a predetermined distance.

The flange part may include at least one spacing protrusion protruding outwardly from the outer surface thereof to secure a distance between the outer surface of the flange part and an inner peripheral surface of the core.

The spacing protrusion maybe formed along an inlet edge of the through-hole.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a transformer according to an embodiment of the present invention;

FIG. 2 is a plan view of the transformer shown in FIG. 1;

FIG. 3 is an exploded perspective view schematically illustrating the transformer shown in FIG. 1;

FIG. 4 is a cross-sectional view taken along line A-A′ of FIG. 2;

FIG. 5 is a partially enlarged cross-sectional view of part B of FIG. 4; and

FIG. 6 is a partially enlarged cross-sectional view of part C of FIG. 4.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

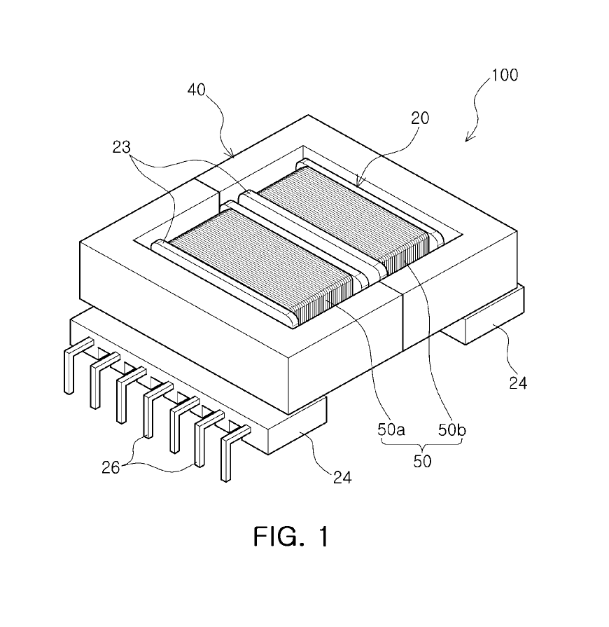

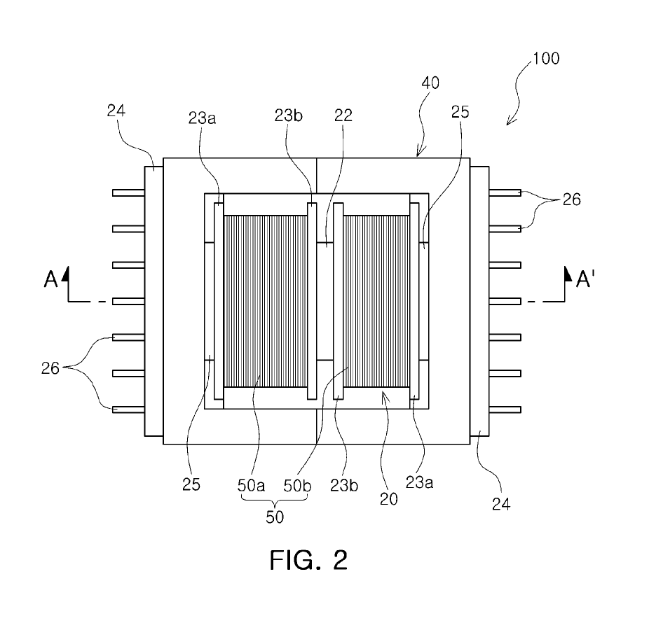

FIG. 1 is a perspective view schematically illustrating a transformer according to an embodiment of the present invention; FIG. 2 is a plan view of the transformer shown in

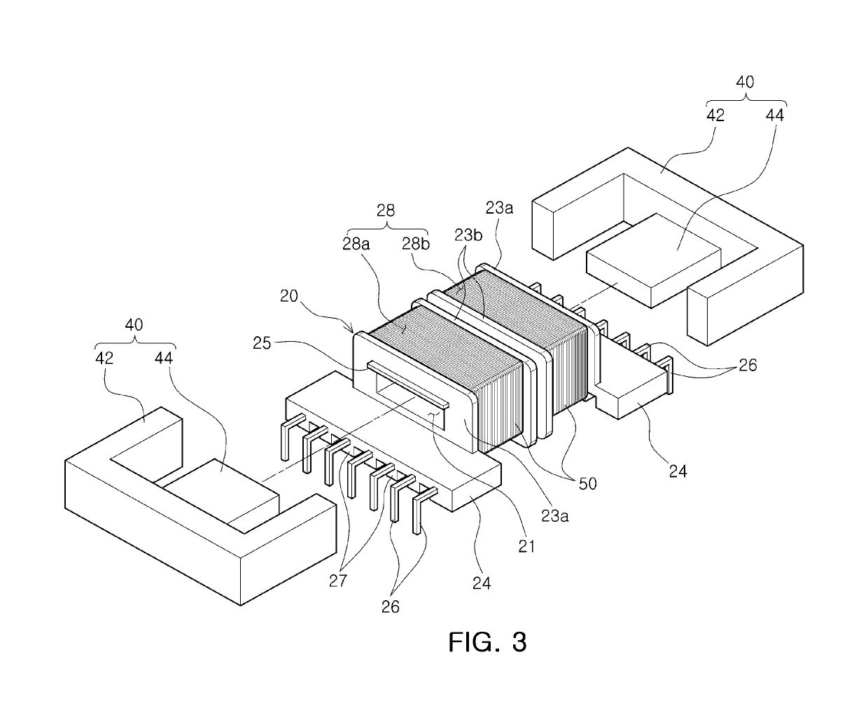

FIG. 1; and FIG. 3 is an exploded perspective view schematically illustrating the transformer shown in FIG. 1.

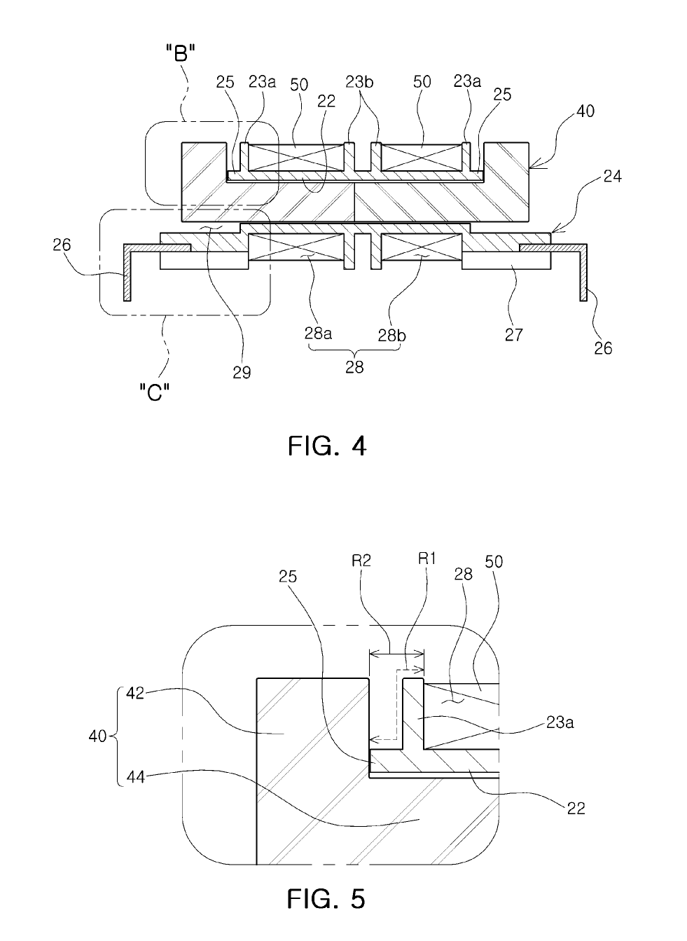

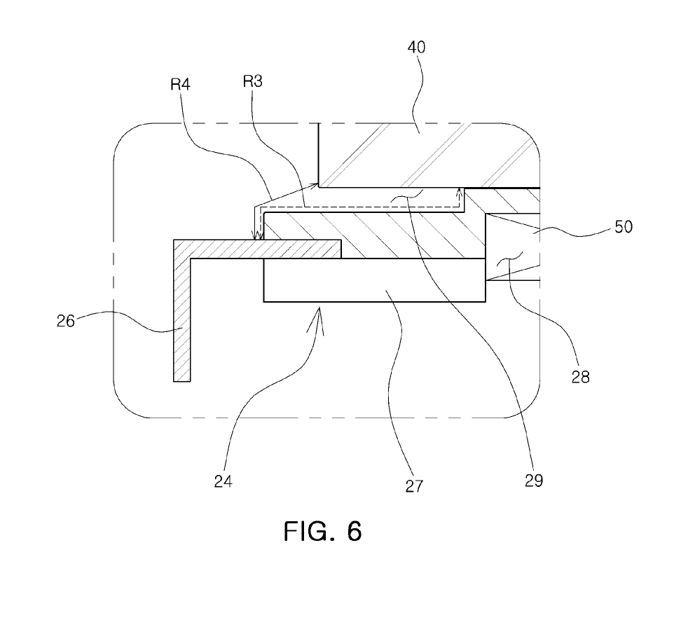

In addition, FIG. 4 is a cross-sectional view taken along line A-A′ of FIG. 2; FIG. 5 is a partially enlarged cross-sectional view of part B of FIG. 4; and FIG. 6 is a partially enlarged cross-sectional view of part C of FIG. 4.

Referring to FIGS. 1 through 6, a transformer 100 according to the embodiment of the present invention may include a coil part 50, a bobbin 20, and a core 40.

The coil part 50 (hereinafter, referred to as “coils 50”) may include a primary coil 50a and a secondary coil 50b.

The primary coil 50a maybe wound on a first wining part 28a formed in the bobbin 20 to be described below.

Further, the primary coil 50a according to the embodiment of the present invention may include a plurality of coils wound on the first winding part 28a and electrically insulated from each other. That is, in the transformer 100 according to the present embodiment, the primary coil 50a includes the plurality of coils, such that various voltages may be applied and correspondingly, be drawn through the secondary coil 50b.

To this end, respective coils configuring the primary coil 50a may have different thicknesses and turn amounts. In addition, as the primary coil 50a, a single strand of wire may be used or a Ritz wire formed by twisting several strands may be used.

Lead wires (not shown) of the primary coil 50a may be connected to external connection terminals 26 included in the bobbin 20.

The secondary coil 50b maybe wound on a second winding part 28b formed in the bobbin 20.

Similar to the above-mentioned primary coil 50a, the secondary coil 50b may also include a plurality of coils electrically insulated from each other. Lead wire (not shown) of the secondary coil 50b may be connected to the external connection terminals 26 included in the bobbin 20.

The bobbin 20 may include a pipe shaped body part 22 having a through-hole 21 formed in the center of an inner portion thereof, flange parts 23 including external and internal flange parts 23a and 23b and vertically extended from both ends of the body part 22 in an outer diameter direction thereof, the external connection terminals 26 for electrical and physical connection with the outside, and a terminal connection part 24 having the external connection terminals 26 connected thereto, as shown in FIG. 2.

The through-hole 21 formed in the body part 22 may be used as a path through which a part (for example, an insertion part 44) of the core 40 is inserted. The case in which the through-hole 21 has a rectangular cross section is described by way of example in the present embodiment. The cross-sectional shape of the through-hole 21 described above may correspond to a shape of the core 40 inserted into the through-hole 21. Therefore, in the bobbin 20 according to the embodiment of the present invention, the through-hole 21 is not limited to having the above-mentioned shape, and the shape thereof may be variously formed corresponding to shape of the core 40 inserted thereinto.

The flange parts 23 are divided into the external flange part 23a and the internal flange part 23b according to a formation position thereof. In addition, a space between an outer peripheral surface of the body part 22 and the external and internal flange parts 23a and 23b may be used as a winding part 28 on which the coils 50 is wound. Therefore, the flange parts 23 may serve to protect the coils 50 from the outside and secure insulation properties between the outside and the coils 50, while serving to support the coils 50 wound on the winding part 28 at both sides thereof.

In addition, the external flange part 23a according to the present embodiment may include at least one spacing protrusion 25 formed on an outer surface thereof.

The spacing protrusion 25 may be formed at a position adjacent to the through-hole 21 on the outer surface of the external flange part 23a. More specifically, the spacing protrusion 25 according to the present embodiment may be formed along an outer peripheral surface of the through-hole 21. In the present embodiment, the case in which the spacing protrusion 25 is formed to elongate along an inlet edge of the through-hole 21 disposed at an upper portion of the through-hole 21 is described by way of example.

This configuration has been derived since the core 40 according to the present embodiment has a shape in which the core 40 protrudes upwardly at an outer portion of the external flange part 23a. Therefore, in the case in which the core 40 has a shape in which the core 40 protrudes downwardly at the outer portion of the external flange part 23a, the spacing protrusion 25 may be formed along an inlet edge of the through-hole 21 disposed at a lower portion of the through-hole 21.

The spacing protrusion 25 may protrude by a distance sufficient to secure a creepage distance R1 (See FIG. 5) from the coils 50 (particularly, the coil wound to be adjacent to the external flange part) wound on the winding part 28 to the core 40 (particularly, an outside part 42 disposed on the terminal connection part. Therefore, the protruded distance of the spacing protrusion 25 may be determined according to a width of the flange parts 23.

In order to secure the creepage distance R1 by as much as possible, the spacing protrusion 25 may be formed along the inlet edge of the through-hole 21, as described above. However, in the case in which the external flange part 23a has a sufficiently wide width to secure the creepage distance in advance, the spacing protrusion 25 is not limited to being positioned in the vicinity of the inlet of the through-hole 21 of the external flange part 23a, and may be positioned in any position as long as the spacing protrusion 25 protrudes between the external flange part 23a and the core 40 to allow the external flange part 23a and the core 40 to be spaced apart from each other.

In addition, the spacing protrusion 25 may protrude by a distance sufficient to secure an insulation distance R2 (See FIG. 2) from the coils 50 wound on the winding part 28 to the core 40. Therefore, the spacing protrusion 25 may protrude by a distance of 1 mm or more. However, the present invention is not limited thereto.

In addition, an outer surface and an outer peripheral surface of the flange parts 23 according to the present embodiment may be respectively disposed to be spaced apart by a predetermined distance from an inner surface of the outside part 42 of the core 40, to be described below. This may be configured by reducing a width of the flange parts 23 or increasing a size of the outside part 42 of the core 40.

Therefore, the coils 50 wound on the winding part 28 may be disposed to be spaced apart from the inner surface of the outside part 42 of the core 40, and the flange parts 23 of the bobbin 20 may also be disposed to be spaced apart from the core 40. Therefore, a creepage distance and an insulation distance between the core 40 and an outer surface of the coil 50 may be secured.

The terminal connection part 24 may be formed on an outer surface of the external flange part 23a of the bobbin 20.

More specifically, the terminal connection part 24 may be disposed on a lower portion of the external flange part 23a spaced apart from the inlet of the through-hole 21 by a predetermined distance and horizontally protrude in such a manner as to be extended outwardly from the external flange part 23a in a length direction of the body part 22.

Here, a distance by which the terminal connection part 24 is spaced apart from the through-hole 21 may be determined according to a position at which a lower surface of the core 40 is disposed. More specifically, the terminal connection part 24 according to the present embodiment may be spaced apart from the through-hole 21 by a distance at which an upper surface thereof may be spaced apart from the lower surface of the core 40 by a predetermined interval.

This spaced distance may be provided in order to secure a creepage distance R3 (See FIG. 6) and an insulation distance R4 (See FIG. 6) between external connection terminals 26 to be described below and the core 40. That is, a spaced space 29 is formed between the upper surface of the terminal connection part 24 and the lower surface of the core 40, such that the insulation distance R4 between the core 40 and the external connection terminals 26 may be secured and the creepage distance R3 may be secured in the entire length direction of the terminal connection part 24 which protrudes.

The terminal connection part 24 may include the external connection terminals 26 and guide protrusions 27.

A plurality of external connection terminals 26 may be provided and connected to the terminal connection part 24 such that they protrude from the terminal connection part 24 in the length direction of the body part 22 or in a downward direction.

A plurality of guide protrusions 27 may protrude downwardly from a lower surface of the terminal connection part 24 so as to be in parallel with each other. The guide protrusion 27 may guide the lead wires of the coil 50 wound on the winding part 28 of the bobbin 20 in such a manner that the lead wires may be easily connected to the external connection terminals 26. Therefore, the guide protrusion 27 may protrude by a thickness equal to or larger than a diameter of the lead wire of the coil 50 in order to firmly guide the coil 50.

Due to the configuration of the terminal connection part 24 as described above, the lead wire of the coil 50 wound on the winding part 28 may be led to a lower portion of the bobbin 20 and be then electrically connected to the external connection terminal 26 through a space between the guide protrusions 27.

The bobbin 20 may be easily manufactured by injection molding, but is not limited thereto. That is, the bobbin 20 may also be manufactured by various methods such as a press processing method, and the like. In addition, the bobbin 20 according to the present embodiment maybe made of an insulating resin material and a material having high heat resistance and high voltage resistance. As a material of the bobbin 20, polyphenylenesulfide (PPS), liquid crystal polyester (LCP), polybutyleneterephthalate (PBT), polyethyleneterephthalate (PET), phenolic resin, and the like, may be used.

A part of core 40 may be inserted into the through-hole 21 formed in the inner portion of the bobbin 20 to form a closed magnetic circuit. The core 40 according to the present embodiment may include a pair of cores 40. The pair of cores 40 may be inserted into the through-hole 21 of the bobbin 20 to thereby be connected to each other while facing each other.

As the core 40, an ‘EE’ core, an ‘EI’ core, or the like, may be used.

In addition, in the core 40 according to the present embodiment, apart (hereinafter, referred to as the outside part 42) disposed to surround the body part 22 of the bobbin 20 has a cross section area greater than that of the part (hereinafter, referred to as the insertion part 44) inserted into the through-hole 21. Therefore, a step portion may be formed in a portion in which the insertion part 44 and the outside part 42 are connected to each other.

In addition, an upper surface of the outside part 42 of the core 40 may be disposed at a position corresponding to that of an upper surface of the flange parts 23 of the bobbin 23. For example, the upper surface of the outside part 42 of the core 40 may form approximately the same plane as the upper surface of the flange parts 23 of the bobbin 23.

Therefore, as described above, the spacing protrusion 25 protruding from the external flange part 23a may protrude in such a manner that the spacing protrusion 25 is interposed in a space between the core 40 and the external flange part 23a of the bobbin 20. Therefore, the external flange part 23a and the core 40 may be maintained in a state in which they are spaced apart from each other by a predetermined interval by the spacing protrusion 25.

In addition, lower surfaces of the insertion part 44 and the outside part 42 of the core 40 according to the present embodiment may be disposed on the same plane. That is, the entire lower surface of the core 40 may be formed to be flat without having a part protruding downwardly therefrom.

Therefore, the spaced space 29 having a predetermined distance may be formed between the lower surface of the core 40 and the upper surface of the terminal connection part 24 of the bobbin 20. In addition, the spaced space 29 may be used as a space for securing the creepage distance R3 between the core 40 and the external connection terminals 26.

In addition, the spaced space 29 may protrude by a distance sufficient to secure the insulation distance R4 between the core 40 and the external connection terminals 26. Therefore, the spaced space 29 may have a vertical distance of 1 mm or more. However, the present invention is not limited thereto.

Meanwhile, as needed, the lower surface of the core 40 may not be formed to be flat, but may also be configured so that a portion of the outside part 42 protrudes downwardly. In this case, the bobbin 20 may be formed such that a distance between the through-hole 21 and the terminal connection part 24 further increases corresponding to a protrusion distance of the outside part 42.

The core 40 may be formed of Mn—Zn based ferrite having higher permeability, lower loss, higher saturation magnetic flux density, higher stability, and lower production cost, as compared to other materials. However, in the embodiment of the present invention, a form or a material of the core 40 is not limited.

As set forth above, in the transformer according to the present embodiment configured as described above, the entire winding part may be spaced apart from the inner surface of the core by a predetermined distance. In addition, the terminal connection part to which the external connection terminals are connected may also be spaced apart from the core by a predetermined distance. Therefore, the insulation distances or the creepage distances between the core and the coils and between the core and the external connection terminals can be easily secured without a separate insulating tape or insulating cover.

Therefore, since a separate insulating member used in the related art may be omitted, a time and a cost required to further include the separate insulating member can be reduced.

In addition, the insulating members according to the related art have acted as a factor of increasing a size of a transformer. Therefore, in the case in which the insulating member is omitted as in the present invention, the entire size of the transformer can be significantly reduced.

Meanwhile, the transformer according to the present invention described above is not limited to the above-mentioned embodiments, but may be variously applied.

For example, although the case in which the terminal connection part is disposed at a lower portion of the transformer has been described by way of example in the transformer according to the embodiment of the present invention, the terminal connection part may also be disposed at an upper portion of the transformer.

Further, although the transformer has been described by way of example in the present embodiment, the present invention is not limited thereto, but may be widely applied to any coil component including a core and a coil.

While the present invention has been shown and described in connection with the embodiments, it will be apparent to those skilled in the art that modifications and variations can be made without departing from the spirit and scope of the invention as defined by the appended claims.

What is claimed is:

1. A transformer comprising:
a bobbin including a pipe shaped body part having a through-hole formed therein and a flange part protruding outwardly of the body part;
a plurality of coils wound on the body part of the bobbin; and
a core inserted into the through-hole of the bobbin to form a magnetic circuit,
wherein both an outer surface and an outer peripheral surface of the flange part are disposed to be spaced apart from an inner peripheral surface of a core by a predetermined interval.

2. The transformer of claim 1, wherein a part of the core, disposed on an outer portion of the body part, has an upper surface formed on approximately the same plane as that of an upper surface of the bobbin.

3. The transformer of claim 2, wherein the bobbin includes a terminal connection part protruding from the outer surface of the flange part and having an external connection terminal connected thereto.

4. The transformer of claim 3, wherein the terminal connection part protrudes from a position spaced apart from the through-hole by a predetermined distance in a downward direction.

5. The transformer of claim 3, wherein the core has a lower surface spaced apart from an upper surface of the terminal connection part by a predetermined distance.

6. The transformer of claim 1, wherein the flange part includes at least one spacing protrusion protruding outwardly from the outer surface thereof to secure a distance between the outer surface of the flange part and an inner peripheral surface of the core.

7. The transformer of claim 6, wherein the spacing protrusion is formed along an inlet edge of the through-hole.
